(19) United States
(12) Patent Application Publication
(10) Pub. No.: US 2004/0076003 A1
(43) Pub. Date: Apr. 22, 2004

(54) Apparatus for illuminating through sight devices

(76) Inventors: Joseph S. Collura, Westlake, OH (US); Kenneth H. Kowalski, Strongsville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/274,784

(22) Filed: Oct. 19, 2002

(51) Int. Cl. F21V 33/00

(52) U.S. Cl. 362/234

(57) ABSTRACT

The present invention provides an apparatus for illuminating through sight devices. Sight devices include sight ports and sight flow indicators. One embodiment of an apparatus of the present invention includes a housing having a closed external configuration and an open central portion forming a frame-like structure. The housing generally forms a channel having at least one opening. The sight light further comprises a plurality of light sources secured within the channel of the housing. The light sources are spaced around the channel and directed so that the light sources will emit light through the opening in the channel toward the outside of the housing.

### FIELD OF THE INVENTION

The present invention relates generally to lighting for sight devices and, more particularly, to an apparatus for illuminating through sight devices.

### BACKGROUND OF THE INVENTION

Sight devices are used to view the contents of vessels (such as tanks and drums) and pipes. Viewing may occur directly or remotely (for example, using a camera). Sight devices include sight ports and sight flow indicators. Sight ports are typically used to view the contents of vessels, and sight flow indicators are typically used to view the contents of pipes. Sight devices are also referred to as sight windows and sight glasses. Although sight devices include sight ports and sight flow indicators, for ease of discussion, only the components of sight ports will be shown and described in detail.

A prior art sight port S shown in FIG. 1. The sight port S includes a base or weld pad B, a window or glass W, a retainer R, and at least one connecting device C. The base B is attached to the vessel by any suitable attachment means, such as welding or mechanical fasteners. The window W and the retainer R are placed over the base B with the window W between the base B and the retainer R. The connecting device C connects the retainer R to the base B. Suitable connecting devices include, but are not limited to, clamps, bolts, screws, studs, and nuts. The sight port S may also include one or more gaskets to provide a better seal between the components of the sight port S and the vessel.

In operation, a user looks through the window W in the sight device S to view the contents of the vessel or pipe. However, since the inside of the vessel or pipe is not illuminated, the user may have difficulty viewing the contents of the vessel or pipe. To overcome this difficulty, a sight light is used with the sight device S. A prior art combination sight/light port is shown in FIG. 2. The combination sight/light port is similar in construction to the sight port S shown in FIG. 1 with the addition of the sight light L. The same reference letters are used for similar sight port components throughout the drawings. This and other combination sight/light ports are commercially available under the Series 5000 Combination Sight/Light Port product line from the Jacoby-Tarbox division of Clark-Reliance Corporation. The sight light L illuminates the contents of the vessel or pipe and thus enables the user to better view the contents of the vessel or pipe through the sight device S.

Prior sight lights can illuminate through the sight device or through a second port in the vessel or pipe. A sight light that illuminates through a second port is undesirable because it requires a second opening in the vessel or pipe. A sight light that illuminates through the sight device is more desirable, but it can obstruct the user's view through the sight device. Additionally, prior sight lights typically comprise a single source of light that requires a high voltage power supply, such as an incandescent or halogen bulb. As a result, these sight lights do not provide uniform lighting, require a lot of power to operate, and give off a lot of heat during operation. Further, prior sight lights typically require modification of the sight device (such as the drilling of holes in the retainer of a sight port) in order to attach the sight light to the sight device. Modification of the sight device is undesirable. Therefore, a need exists for an apparatus for illuminating through sight devices that overcomes the deficiencies in the existing illumination apparatuses.

### SUMMARY OF THE INVENTION

The present invention provides an apparatus for illuminating through sight devices. Sight devices include sight ports and sight flow indicators. One embodiment of the apparatus of the present invention includes a housing having a closed external configuration and an open central portion forming a frame-like structure. The housing generally forms a channel having at least one opening. The sight light further comprises a plurality of light sources secured within the channel of the housing. The light sources are spaced around the channel and directed so that the light sources will emit light through the opening in the channel toward the outside of the housing.

Another embodiment of the apparatus of the present invention includes a housing having a closed external configuration and an open central portion forming a frame-like structure. The housing generally forms a channel having at least one opening. The sight light further comprises a light ring enclosed with the housing. The light ring comprises a base and a plurality of light sources. The base has a configuration that generally corresponds to the configuration of the housing. The base is secured within the channel of the housing. The plurality of light sources is electrically connected to the base. The light sources are spaced around the base and directed so that the light sources will emit light through the opening in the channel toward the outside of the housing. The sight light further comprises a light shield enclosing the channel in the housing for protecting the light ring within the housing.

A further embodiment of the apparatus of the present invention comprises a housing having a generally ring-shaped configuration. The housing forms a generally U-shaped channel having at least one opening. The housing includes a lip, a groove, a shelf, and a cavity. The sight light further comprises a light ring enclosed with the housing. The light ring comprises a base, a plurality of light sources, and a plurality of resistors. The base has a generally ring-shaped configuration. The base is secured within the cavity of the housing. The plurality of light sources is electrically connected to the base. The light sources are spaced around the base and directed so that the light sources will emit light through the opening in the channel toward the outside of the housing. The plurality of resistors are electrically connected to the base between the light sources and a circuit ground. One resistor corresponds to each light source. The sight light further comprises at least one gasket, a light shield, and at least one retaining ring. The gasket is seated against the shelf of the housing for providing a seal between the housing and the light shield. The light shield is seated against the gasket for enclosing the channel in the housing and protecting the light ring within the housing. The retaining ring is seated against the light shield, under the lip of the housing, and within the groove of the housing for retaining the light shield within the housing.

### BRIEF DESCRIPTION OF THE DRAWINGS

FIG. 1 is a top perspective view of a prior art sight port;

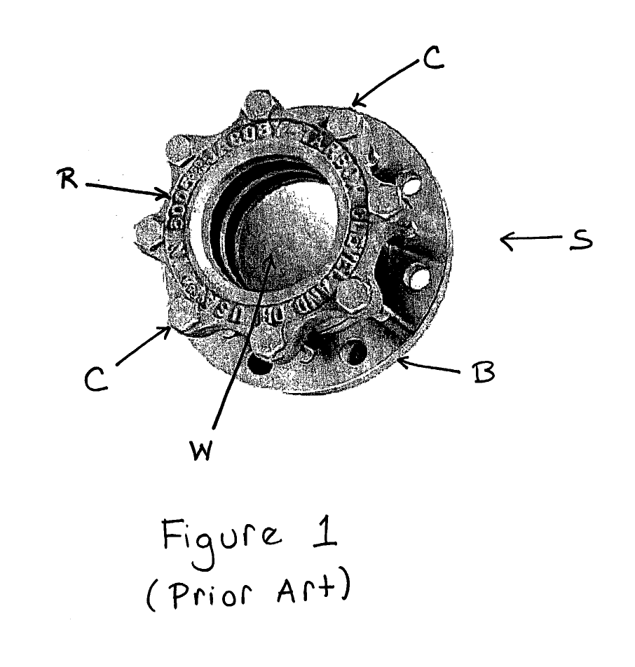

FIG. 2 is a top perspective view of a prior art combination sight/light port;

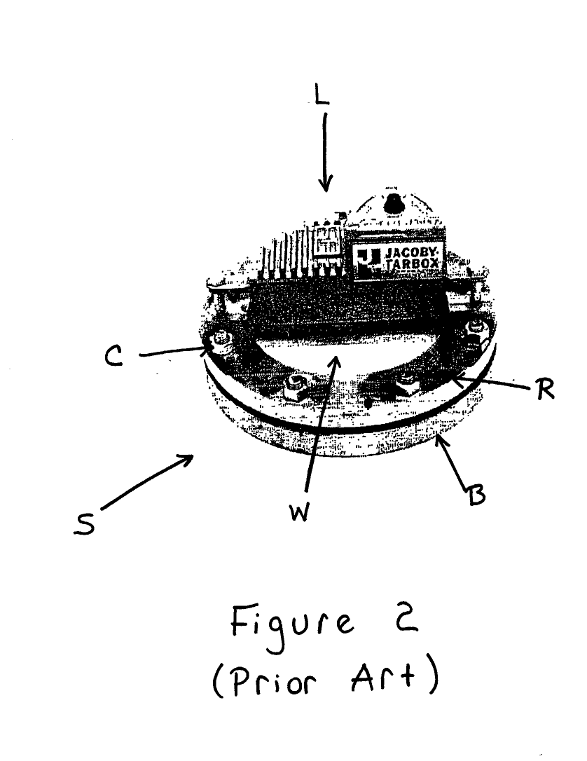

FIG. 3 is a top perspective view of one embodiment of a sight light of the present invention;

FIG. 4 is a bottom perspective view of the sight light of FIG. 3;

FIG. 5 is an exploded perspective view of the components of the sight light of FIG. 3;

FIG. 6 is a cross-sectional view of the housing of the sight light of FIG. 3, taken along the line A-A in FIG. 5;

FIG. 7 is a top perspective view of the sight light of FIG. 3 attached to a sight port; and

FIG. 8 is a cross-sectional view of the sight light of FIG. 3 attached to a sight port, taken along the line B-B in FIG. 7.

### DETAILED DESCRIPTION OF THE INVENTION

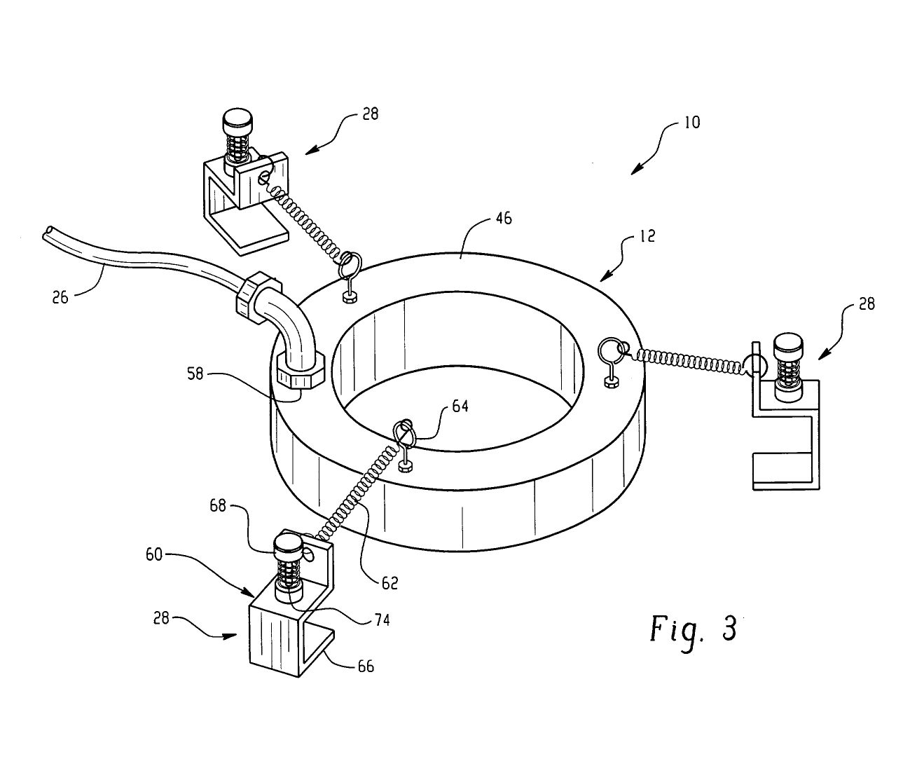

The present invention provides an apparatus for illuminating through sight devices. As stated above, sight devices include sight ports and sight flow indicators. One embodiment of a sight light 10 of the present invention is shown in FIGS. 3, 4, and 5. The sight light 10 includes a housing 12, a light ring 14, inner and outer gaskets 16 and 18, a light shield 20, inner and outer retaining rings 22 and 24, a power cord or conduit 26, and at least one attachment device 28. The structure of each of these components will now be described.

The housing 12 has a generally closed external configuration and an open central portion forming a frame-like structure. The housing 12 generally forms a channel having at least one opening. In one embodiment, the housing 12 is generally circular and ring-shaped. However, one of ordinary skill in the art will appreciate that the housing 12 could have any external configuration, such as a semi-circle, an oval, and any type of polygon. The housing is made of aluminum. However, one of ordinary skill in the art will appreciate that the housing could be made of any suitable housing material, such as stainless steel, carbon steel, and plastic.

The inner and outer diameters of the housing 12 are selected based on the size of the sight port. The inner diameter of the housing 12 is approximately 2 inches smaller than the outer diameter of the housing 12. The outer diameter of the housing 12 is slightly less than the inner diameter of the sight port. The housing inner diameter size enables the light ring 14 to fit inside the housing 12, but also leaves sufficient room to view the contents of the vessel through the center of the sight light 10 and the sight port. The housing outer diameter size enables the light port 10 to fit inside the sight port. In one embodiment for use in a 6 inch sight port, the inner diameter of the housing 12 is approximately 4 inches and the outer diameter of the housing 12 is approximately 5.9 inches.

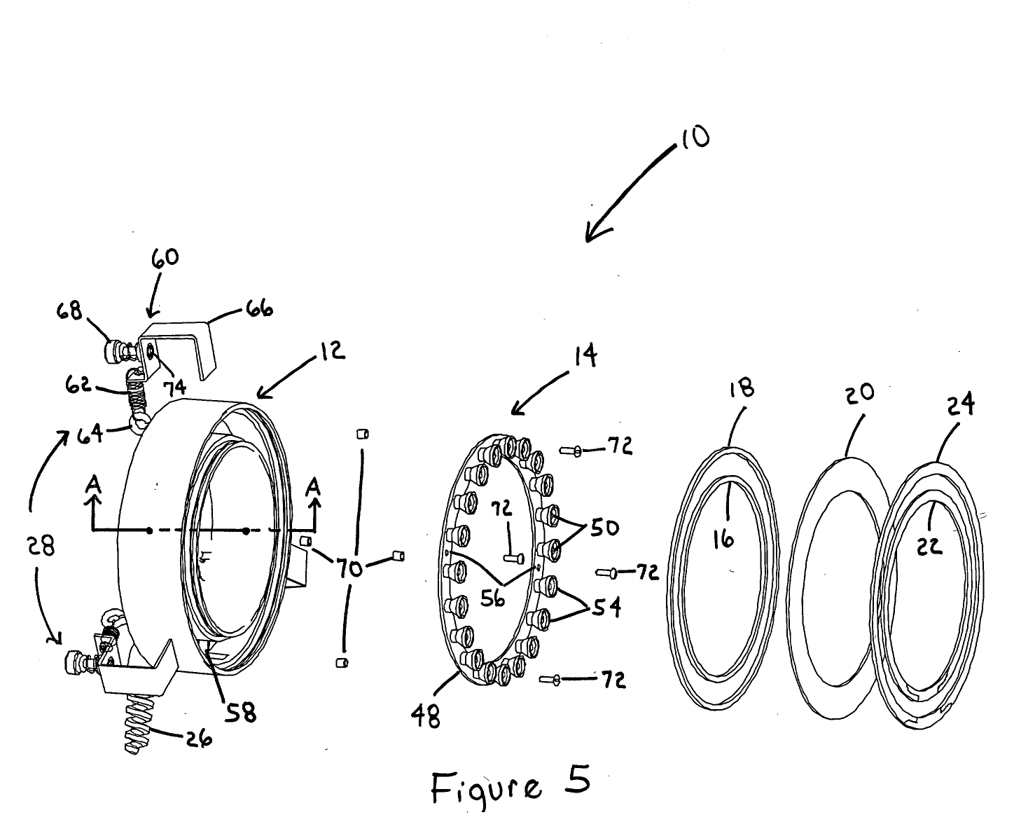

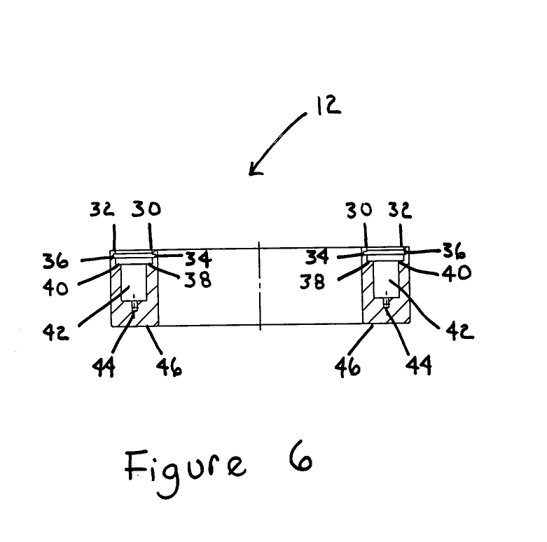

FIG. 6 is a cross-sectional view of the housing 12, taken along the line A-A in FIG. 5. The cross-section of the housing 12 is generally U-shaped. The housing 12 includes inner and outer lips 30 and 32, inner and outer grooves 34 and 36, inner and outer shelves 38 and 40, a cavity 42, at least one tap hole 44, and an outer surface 46. The function of each of these components will be described below.

The light ring 14 includes a base 48, a plurality of light emitting diodes or LEDs 50, a plurality of resistors 52, a plurality of reflecting cups 54, and at least one screw hole 56. The base 48 has a configuration that generally corresponds to the configuration of the housing. In one embodiment, the base 48 is generally circular and ring-shaped. The base 48 is a printed circuit board or PCB. Printed circuit boards are well-known in the art and will not be described in greater detail.

The inner and outer diameters of the base 48 are selected based on the size of the housing 12. The inner diameter of the base 48 is slightly greater than the inner diameter of the cavity 42. The outer diameter of the base 48 is slightly less than the outer diameter of the cavity 42. The base inner and outer diameter sizes enable the light ring 14 to fit inside the housing 12. In one embodiment for use in a 6 inch sight port, the inner diameter of the base 48 is approximately 4.5 inches and the outer diameter of the base 48 is approximately 5.4 inches.

The LEDs 50 are electrically connected to the base 48 by any suitable connection means, such as soldering. The LEDs 50 are connected in parallel by means of printed circuit lines on the base 48. The LEDs 50 are directed so that the LEDs 50 will emit light away from the base 48 toward the outside of the housing 12. In one embodiment, there are twenty (20) LEDs 50 evenly spaced around the base 48. One of ordinary skill in the art will appreciate that any number of LEDs 50 could be used depending on the intensity of the light desired. Moreover, one of ordinary skill in the art will appreciate that the LEDs 50 could be spaced in any manner around the base 48. However, if even lighting is desired, the LEDs 50 should be relatively evenly spaced around the base 48.

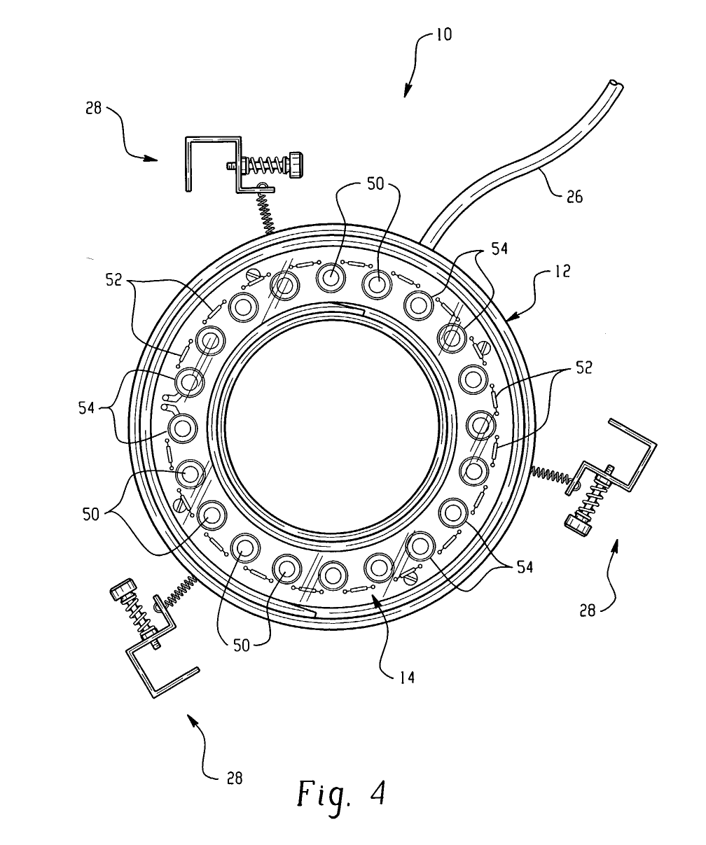

The resistors 52 are current limiting resistors. The resistors 52 are electrically connected to the base 48 by any suitable connection means, such as soldering. Each LED 50 has a corresponding resistor 52 with the resistor 52 electrically connected between the LED 50 and the circuit ground. The reflecting cups 54 increase the amount of light emitted from the LEDs 50 that is directed toward the outside of the housing 12. The reflecting cups 54 are pressed down over the LEDs 50 until the reflecting cups 54 are substantially surrounding the LEDs 50. The reflecting cups 54 are held in place by means of a tight fit between the LEDs 50 and the reflecting cups 54. In one embodiment, each LED 50 has a corresponding reflecting cup 54 (as shown in FIG. 5). However, one of ordinary skill in the art will appreciate that fewer or no reflecting cups 54 could be used without affecting the overall functioning of the sight light 10 (as shown in FIG. 4 where two (2) reflecting cups 54 are used).

The inner and outer gaskets 16 and 18, the light shield 20, and the inner and outer retaining rings 22 and 24 help protect the light ring 14 within the housing 12 from the environment, such as dust or water. The inner and outer gaskets 16 and 18 seat against the inner and outer shelves 38 and 40, respectively. The light shield 20 seats against the inner and outer gaskets 16 and 18. The inner retaining ring 22 seats against the light shield 20 and in the inner groove 34. The outer retaining ring 24 seats against the light shield 20 and in the outer groove 36.

The inner and outer gaskets 16 and 18 are made of neoprene rubber. However, one of ordinary skill in the art will appreciate that the inner and outer gaskets 16 and 18 can be made of any suitable sealing material, such as other types of rubber, teflon, silicon, and foam. Moreover, one of ordinary skill in the art will appreciate that other sealing means could be used in place of the inner and outer gaskets 16 and 18, such as O-rings, caulking, adhesives, and epoxies. The inner diameter of the inner gasket 16 is slightly greater than the diameter of the inner lip 30. The outer diameter of the inner gasket 16 is approximately the same as the inner diameter of the cavity 42. The inner diameter of the outer gasket 18 is approximately the same as the outer diameter of the cavity 42. The outer diameter of the outer gasket 18 is slightly less than the diameter of the outer lip 32.

The light shield 20 is made of a transparent polycarbonate. However, one of ordinary skill in the art will appreciate that the light shield 20 could be made of any suitable transparent shielding material, such as other types of plastic or glass. The inner diameter of the light shield 20 is slightly greater than the diameter of the inner lip 30. The outer diameter of the light shield 20 is slightly less than the diameter of the outer lip 32.

The inner and outer retaining rings 22 and 24 are made of stainless steel. However, one of ordinary skill in the art will appreciate that the inner and outer retaining rings 22 and 24 could be made of any suitable retaining material, such as carbon steel, aluminum, and plastic. The inner diameter of the inner retaining ring 22 is slightly greater than the diameter of the inner groove 34. The outer diameter of the inner retaining ring 22 is approximately the same as the inner diameter of the cavity 42. The inner diameter of the outer retaining ring 24 is approximately the same as the outer diameter of the cavity 42. The outer diameter of the outer retaining ring 24 is slightly less than the diameter of the outer groove 36. In one embodiment, the inner and outer retaining rings 22 and 24 are not enclosed rings so that the inner and outer retaining rings 22 and 24 can be wrapped in the inner and outer grooves 34 and 36, respectively, and under the inner and outer lips 30 and 32, respectively. Moreover, the inner and outer retaining rings 22 and 24 may be long enough to be wrapped more than once in the inner and outer grooves 34 and 36, respectively.

The power cord or conduit 26 carries power to the LEDs 50. The power cord or conduit 26 is electrically connected to the base 48, is inserted through an opening 58 in the outer surface 46 of the housing 12, and is electrically connected to a power supply (not shown). The power supply is a low voltage direct current (DC) power supply. In one embodiment of the present invention, the power supply is a twenty-four volt direct current (24VDC) power supply. Power supplies are well known in the art and will not be described in detail.

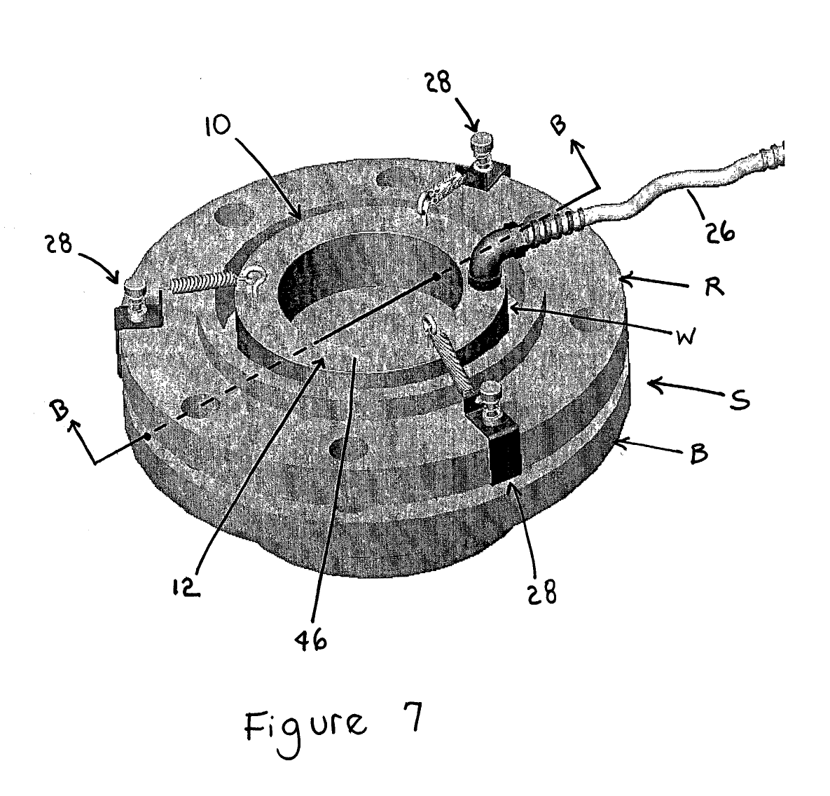

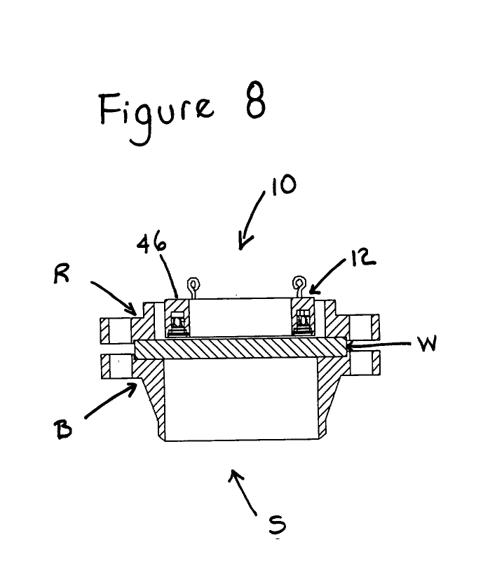

The attachment device 28 attaches the sight light 10 to a sight device. As stated above, sight devices include sight ports and sight flow indicators. One of ordinary skill in the art will appreciate that the sight light 10 of the present invention can be attached to both sight ports and sight flow indicators. However, for ease of discussion, only the attachment of the sight light 10 to a sight port will be shown and described in detail. FIG. 7 shows one embodiment of the sight light 10 of the present invention attached to a sight port S, and FIG. 8 is a cross-sectional view of the sight light 10 attached to the sight port S, taken along the line B-B in FIG. 7.

The attachment device 28 includes a clamp 60, a spring 62, and an eyebolt 64. The clamp 60 includes a bracket 66 and a thumb screw 68. The bracket 66 is inserted over an outer circumferential edge of the retainer R of the sight port S. The thumb screw 68 is turned until the bracket 66 is secured to the sight port S. The eyebolt 64 is screwed into the outer surface 46 of the housing 12. The spring 62 is attached to both the eyebolt 64 and the bracket 66 and secures the sight light 10 to the sight port S. In one embodiment, three (3) attachment devices 28 are used. However, one of ordinary skill in the art will appreciate that fewer or more attachment devices 28 could be used. Moreover, one of ordinary skill in the art will appreciate that other attachment means could be used in place of the attachment device 28, such as other types of clamps, levers, and adhesives.

In order to assemble the sight light 10, the power cord 26 is inserted through the opening 58 in the outer surface 46 of the housing 12. The LEDs 50 and the resisters 52 are electrically connected to the base 48 of the light ring 14, and the reflecting cups 54 are pressed down over the LEDs 50. Spacers 70 are inserted in the tap holes 44 in the housing 12. The power cord 26 is electrically connected to the base 48. The base 48 is inserted in the cavity 42 of the housing 12 so that the screw holes 56 are aligned with the spacers 70. Screws 72 are inserted through the tap holes 44 and are screwed into the spacers 70 securing the base 48 in the cavity 42 of the housing 12. The inner and outer gaskets 16 and 18 are seated against the inner and outer shelves 38 and 40 of the housing 12, respectively. The light shield 20 is seated against the inner and outer gaskets 16 and 18. The inner and outer retaining rings 22 and 24 are seated against the light shield 20 and are wrapped in the inner and outer grooves 34 and 36 of the housing 12, respectively, and under the inner and outer lips 30 and 32 of the housing 12, respectively. The eyebolts 64 are screwed into the outer surface 46 of the housing 12, and the springs 62 are attached to both the eyebolts 64 and the brackets 66. The thumb screws 68 are inserted into openings 74 in the brackets 66.

In order to attach the sight light 10 to the sight device S and operate the sight light 10, the sight light 10 is seated against the window W of the sight device S with the LEDs 50 pointing in the direction of the window W. As stated above, sight devices include sight ports and sight flow indicators. One of ordinary skill in the art will appreciate that the sight light 10 of the present invention can be attached to both sight ports and sight flow indicators. However, for ease of discussion, only the attachment of the sight light 10 to a sight port will be described in detail. The brackets 66 are inserted over the outer circumferential edge of the retainer R of the sight port S. The thumb screws 68 are turned until the brackets 66 are secured to the sight port S. A similar attachment device would be used and similar steps would be taken to secure the sight light 10 to a sight flow indicator. The power cord 26 is connected to the power supply. The LEDs 50 will emit light through the window W of the sight device S into the inside of the vessel enabling the contents of the vessel or pipe to be viewed through the window W.

One of ordinary skill in the art will now appreciate that the present invention provides an apparatus for illuminating through sight devices. Although the present invention has been shown and described with reference to a particular embodiment, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. An apparatus for illuminating through sight devices, comprising:
a housing having a closed external configuration and an open central portion forming a frame-like structure, the housing generally forming a channel having at least one opening; and
a plurality of light sources secured within the channel of the housing, the light sources being spaced around the channel and directed so that the light sources will emit light through the opening in the channel toward the outside of the housing.

2. The apparatus of claim 1, wherein the light sources are light emitting diodes.

3. The apparatus of claim 1, wherein the light sources are relatively evenly spaced around the channel of the housing.

4. The apparatus of claim 1, further comprising a plurality of resistors, wherein one resistor is electrically connected to each light source.

5. The apparatus of claim 1, further comprising a plurality of reflecting cups, wherein one reflecting cup substantially surrounds each light source.

6. The apparatus of claim 1, further comprising a base, wherein the base is secured within the channel of the housing and the light sources are electrically connected to the base.

7. The apparatus of claim 6, wherein the base is a printed circuit board.

8. An apparatus for illuminating through sight devices, comprising:
a housing having a closed external configuration and an open central portion forming a frame-like structure, the housing generally forming a channel having at least one opening;
a light ring enclosed within the housing, the light ring comprising:
a base having a configuration generally corresponding to the configuration of the housing, the base being secured within the channel of the housing, and
a plurality of light sources electrically connected to the base, the light sources being spaced around the base and directed so that the light sources will emit light through the opening in the channel toward the outside of the housing; and
a light shield enclosing the channel in the housing for protecting the light ring within the housing.

9. The apparatus of claim 8, wherein the light sources are light emitting diodes.

10. The apparatus of claim 8, wherein the light sources are relatively evenly spaced around the base of the light ring.

11. The apparatus of claim 8, further comprising a plurality of resistors electrically connected to the base between the light sources and a circuit ground, wherein one resistor corresponds to each light source.

12. The apparatus of claim 8, further comprising a plurality of reflecting cups, wherein one reflecting cup substantially surrounds each light source.

13. The apparatus of claim 8, wherein the base is a printed circuit board.

14. The apparatus of claim 8, further comprising at least one gasket for providing a seal between the housing and the light shield.

15. The apparatus of claim 8, further comprising at least one retaining ring for retaining the light shield within the housing.

16. The apparatus of claim 8, further comprising at least one attachment device for securing the housing to a sight device.

17. An apparatus for illuminating through sight devices, comprising:
a housing having a generally ring-shaped configuration, the housing forming a generally U-shaped channel having at least one opening, the housing including a lip, a groove, a shelf, and a cavity;
a light ring enclosed within the housing, the light ring comprising:
a base having a generally ring-shaped configuration, the base being secured within the cavity of the housing,
a plurality of light sources electrically connected to the base, the light sources being spaced around the base and directed so that the light sources will emit light through the opening in the channel toward the outside of the housing, and
a plurality of resistors electrically connected to the base between the light sources and a circuit ground, wherein one resistor corresponds to each light source; and
at least one gasket, a light shield, and at least one retaining ring, wherein:
the gasket is seated against the shelf of the housing for providing a seal between the housing and the light shield,
the light shield is seated against the gasket for enclosing the channel in the housing and protecting the light ring within the housing, and
the retaining ring is seated against the light shield, under the lip of the housing, and within the groove of the housing for retaining the light shield within the housing.

18. The apparatus of claim 17, wherein the light sources are light emitting diodes.

19. The apparatus of claim 17, wherein the light sources are relatively evenly spaced around the base of the light ring.

20. The apparatus of claim 17, further comprising a plurality of reflecting cups, wherein one reflecting cup substantially surrounds each light source.

21. The apparatus of claim 17, wherein the base is a printed circuit board.

22. The apparatus of claim 17, further comprising at least one attachment device for securing the housing to a sight device.
